(19) United States
(12) Patent Application Publication
(10) Pub. No.: US 2022/0095582 A1
(43) Pub. Date: Mar. 31, 2022

(54) Pet Carrying Device with Attachment for Chairs

(71) Applicant: Sarah Beth Allison, Charleston, SC (US)

(72) Inventor: Sarah Beth Allison, Charleston, SC (US)

(21) Appl. No.: 17/478,812

(22) Filed: Sep. 17, 2021

Related U.S. Application Data
(60) Provisional application No. 63/083,736, filed on Sep. 25, 2020.

(51) Int. Cl. A01K 1/02

(52) U.S. Cl. CPC A01K 1/0272

(57) ABSTRACT

The pet carrying device is intended to provide pet owners an equipment that is able to house and hold their pets within environments of a chair. To accomplish this, the device includes multiple length adjustable straps, fasteners, belt loops, and hook and loop attachments. Accordingly, the device is able to tightly attach to chairs such as an office chair or a car seat with the plurality of adjustable straps and fasteners. In addition, the device provides pet owners a portable pet carriage that allow pet owners to bring their pet alongside within environments with a chair.

The current application claims a priority to the U.S. Provisional Patent application Ser. No. 63/083,736 filed on Sep. 25, 2020.

### FIELD OF THE INVENTION

The present invention relates to pet carriages. The present invention is a portable pet carriage that can be attached to chairs and seats.

### BACKGROUND OF THE INVENTION

Pet owners of any type understand the unconditional love that is needed to take care of their pet whether it is a dog, cat, lizard, guinea pig, etc. It is common then that a pet owner can miss the presence of their pet as they are away from home for an extended period of time. For example, for pet owners who work an office job away from home or of the likes will be unable to bring their pet with them due to the problematic issue of having no secure and safe way of watching their pet while they work. Another example of the issue of unsupervised pet is a situation of working at home. It is common that people who work from home are to isolate themselves with their work material in order to have no external distraction, including their pet. With this issue, if the pet owners were to bring their pet to work, they will need to keep their pets safe and nearby while they work. Pet owners have no systematic way of watching over their pet while working in an environment such as an office or home office.

The objective of the present invention is to provide pet owners an equipment that is able to house and hold their pets within environments of a chair. The present invention is able to tightly attach to chairs such as an office chair or a car seat. In addition, the present invention provides pet owners a portable pet carriage that allow pet owners to bring their pet alongside within environments with a chair.

### BRIEF DESCRIPTION OF THE DRAWINGS

FIG. 1 is a top-front perspective view of the present invention, wherein a plurality of straps is detached and placed adjacent the receptacle.

FIG. 2 is an exploded top-front-left perspective view of the present invention.

FIG. 3 is a front elevational view of the receptacle without a cover.

FIG. 4 is a rear elevational view of the receptacle without the cover.

FIG. 5 is a left elevational view of the of the receptacle without the cover.

FIG. 6 is a bottom plan view of the receptacle without the cover.

FIG. 7 is a top plan view of the receptacle without the cover.

FIG. 8 is a top-rear perspective view of the present invention, wherein a shoulder strap is attached to two fastening loops at the first end of the receptacle.

FIG. 9 is a front perspective view of the present invention being attached to a car.

FIG. 10 is a rear perspective view of the present invention being attached to the passenger seat of a car.

FIG. 11 is a perspective view of the present invention with a pet, wherein the present invention is positioned in a seat of a car.

FIG. 12 is a top right rear perspective view of the present invention being attached to the handle of an office chair.

FIG. 13 is a detailed rear perspective view of the present invention being attached to the handle of an office chair.

FIG. 14 is a top front right perspective view of the present invention on a chair, wherein a pet is sitting within the inner compartment of the present invention.

### DETAIL DESCRIPTIONS OF THE INVENTION

All illustrations of the drawings are for the purpose of describing selected versions of the present invention and are not intended to limit the scope of the present invention.

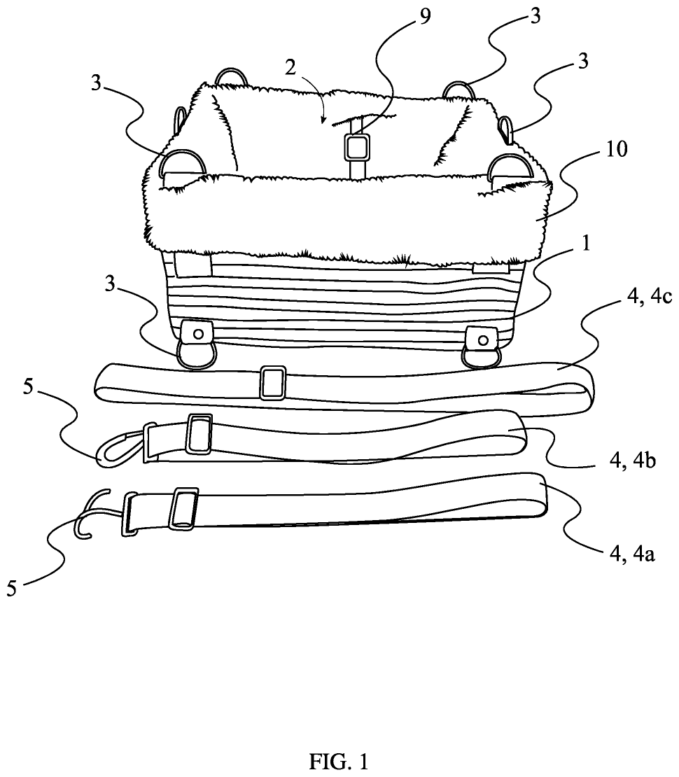

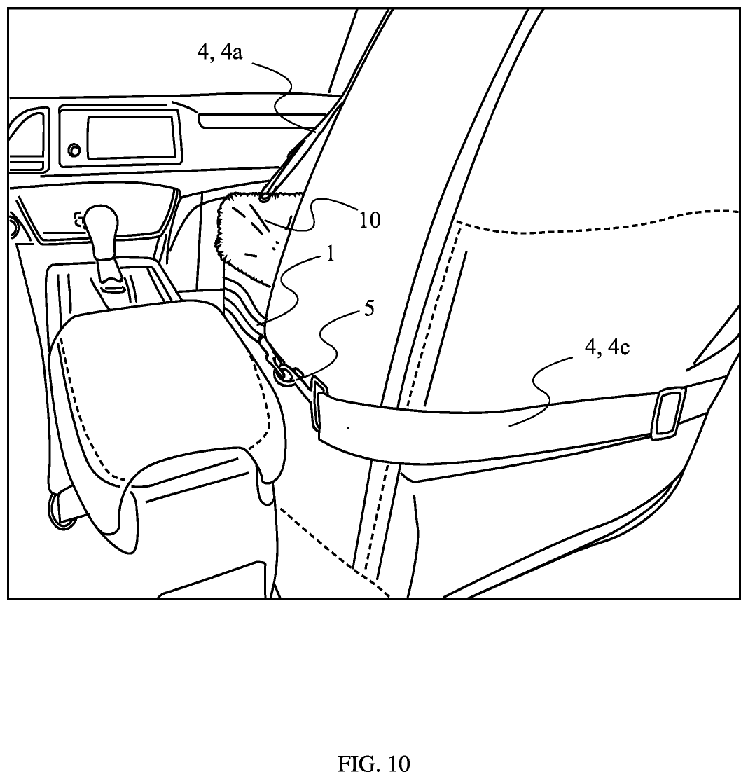

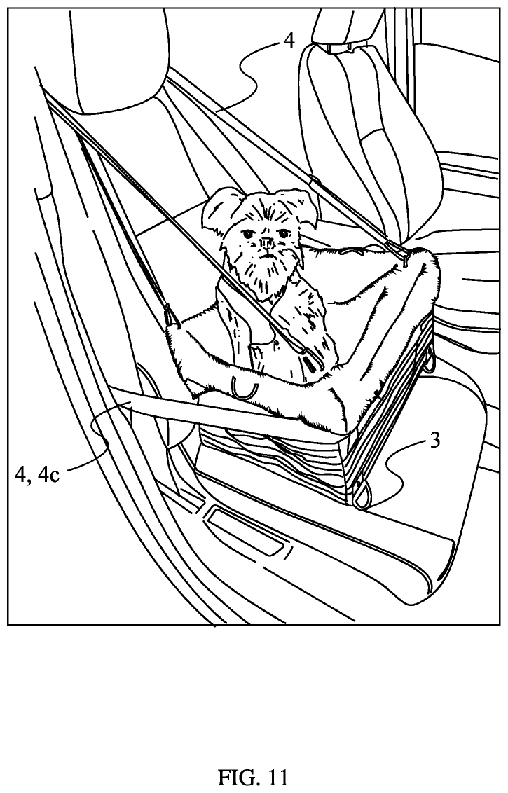

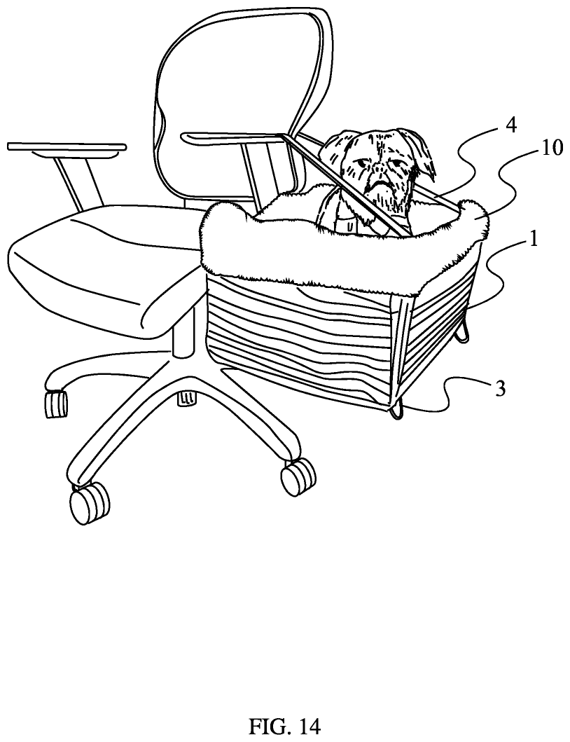

In reference to FIG. 1 through FIG. 14, the present invention is a pet carrying device. The objective of the present invention is to provide pet owners an equipment that is able to house and hold their pets within environments of a chair. To accomplish this, the present invention comprises multiple length adjustable straps, fasteners, belt loops, hook and loop attachments etc. Accordingly, the present invention is able to tightly attach to chairs, such as an office chair or a car seat. In addition, the present invention provides pet owners a portable pet carriage that allow pet owners to bring their pet alongside within environments of a chair.

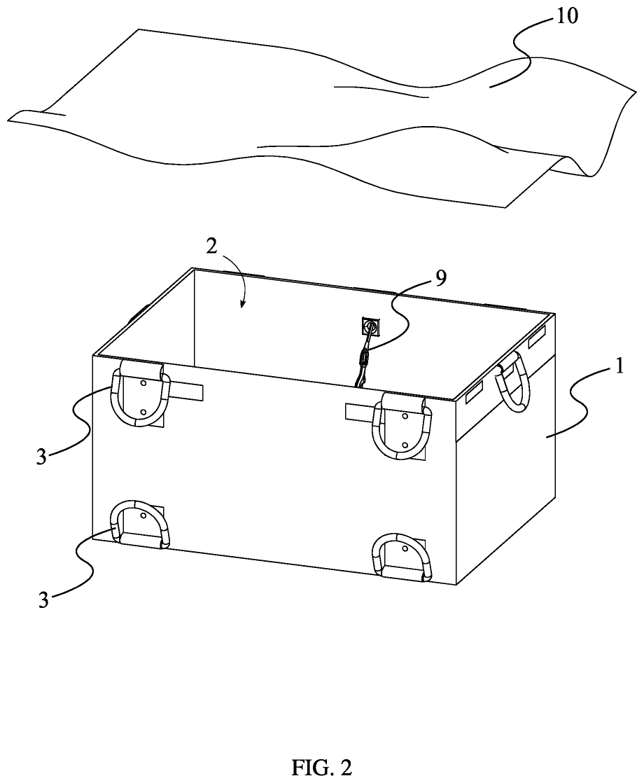

The following description is in reference to FIG. 1 through FIG. 14. According to a preferred embodiment of the present invention, the pet carrying device comprises a receptacle 1, an inner compartment 2, a plurality of fastening loops 3, and a plurality of adjustable straps 4. Preferably, the receptacle 1 of the present invention is the main structure of the pet carrying device. The receptacle 1 is a sturdy hollow rectangular box as seen in FIG. 1 and FIG. 2. Accordingly, the inner compartment 2 traverses into the receptacle 1, and the inner compartment 2 extends from a first end 1a of the receptacle 1 towards a second end 1b of the receptacle 1, wherein the first end 1a is positioned opposite to the second end 1b across the receptacle 1. This is so that a pet may reside within the inner compartment 2 comfortably. Preferably, the receptacle 1 comprises a sturdy fabric sewn in the shape of a box, or a lightweight wooden box wrapped in a fabric. However, the receptacle 1 may comprise any other shape, size, material, components, and arrangement of components that are known to one of ordinary skill in the art, as long as the intents of the present invention are fulfilled.

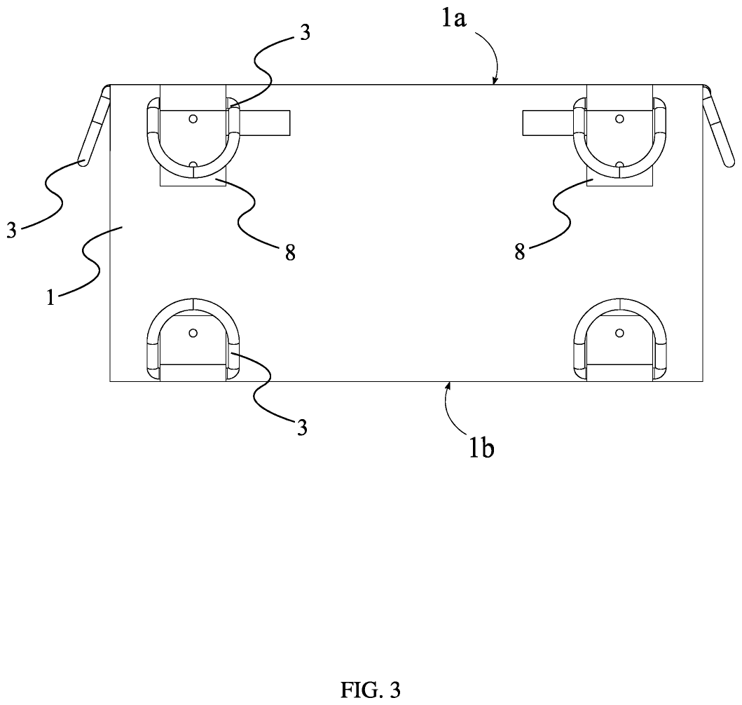

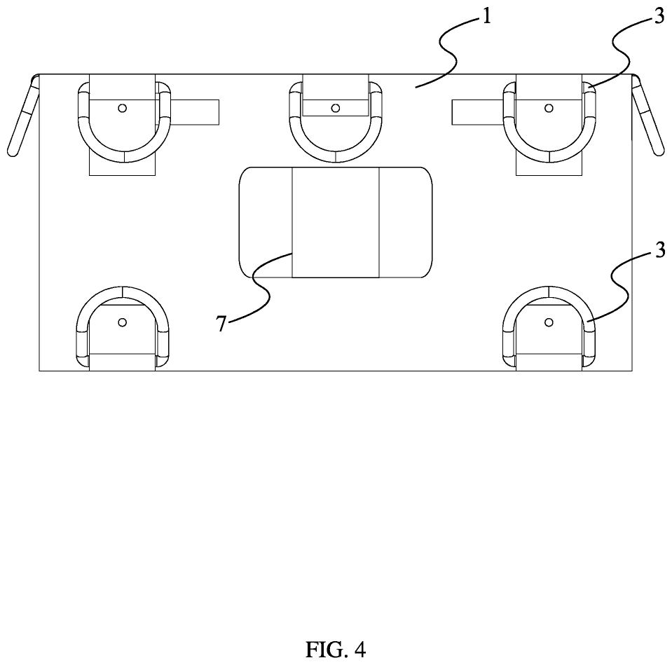

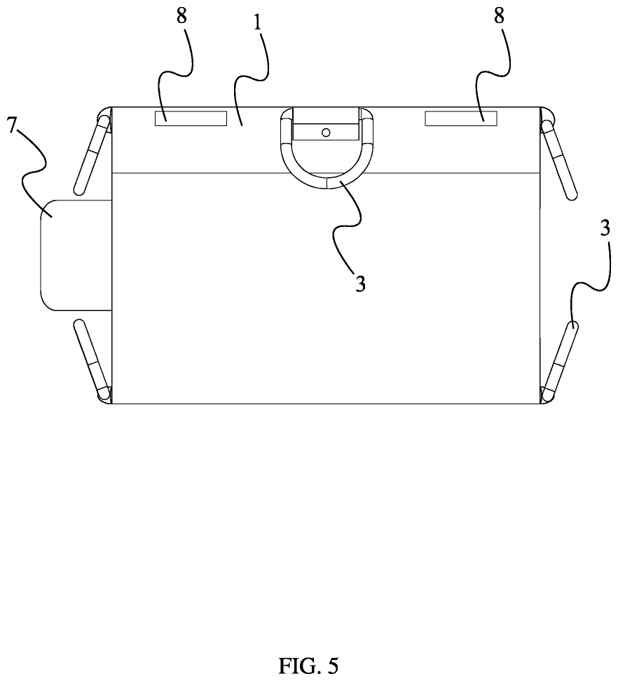

According to the preferred embodiment, the plurality of fastening loops 3 is laterally and perimetrically mounted onto the receptacle 1. Preferably, the plurality of fastening loops 3 is D-shaped metallic rings utilized to assist the attachment of the present invention to a chair. The plurality of fastening loops 3 is the hardware on the present invention that enable the plurality of adjustable straps 4 to safely and securely attach to a chair. As seen in FIG. 1 through FIG. 7, the plurality of fastening loops 3 may be found on the front, rear, left-side, and right-side of the receptacle 1. In reference to FIG. 3, the front surface has four D-shaped rings, positioned adjacent the four corners of the front surface. In reference to FIG. 4, a rear view of the present invention is shown. The rear surface has five D-shaped rings, positioned adjacent the four corners as well as in the top middle region. In reference to FIG. 5, a side view of the present invention is shown. Both side surfaces of the receptacle have one D-shaped ring, positioned around the top middle region, as seen in FIG. 5. Thus, preferably, the plurality of fastening loops 3 is positioned adjacent the first end 1a and adjacent the second end 1b of the receptacle 1. However, the plurality of fastening loops 3 may comprise any other size, shape, location, components and arrangement of components, as long as the intents of the present invention are not altered.

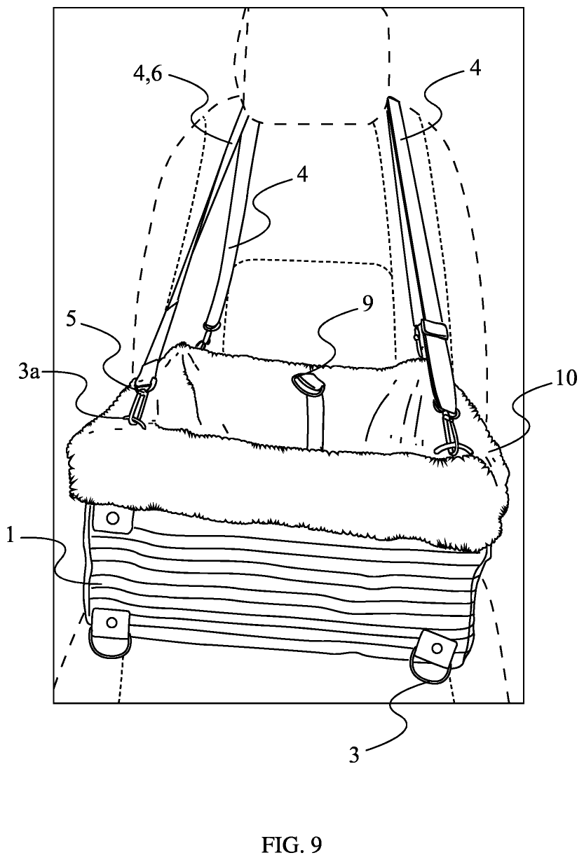

Continuing with the preferred embodiment, the plurality of adjustable straps 4 is utilized to attach and support the present invention to a chair. Preferably, the plurality of adjustable straps 4 is made out of a soft and sturdy fabric material similar to a standard backpack strap, or of the likes. As seen in FIG. 1, the plurality of adjustable straps 4 is detachably connected to the receptacle 1, such that the receptacle may be detachably mounted onto a chair. In other words, the plurality adjustable straps 4 may be detached from the receptacle 1, when not in use. Further, the plurality of adjustable straps 4 may be adjusted to a variety of lengths and sizes needed for the user. This is so that, when in operation, the plurality of adjustable straps 4 maybe wrapped around any chair or a passenger seat of any car. To accomplish effective fastening of the plurality of adjustable straps 4 to the receptacle 1, each of the plurality of adjustable straps 4 comprises a plurality of fastening clips 5. Further, each of the plurality of fastening clips 5 is terminally mounted onto a corresponding strap 6, wherein the corresponding strap 6 is from the plurality of adjustable straps 4. Thus, as seen in FIG. 9, during operation, each of the plurality of fastening clips 5 is removably engaged with a corresponding loop 3a, wherein the corresponding loop 3a is from the plurality of fastening loops 3. As clearly seen in FIG. 3 and FIG. 4, the plurality of fastening clips 5 comprises D-clips. However, the plurality of fastening clips 5 and the plurality of adjustable straps 4 may comprise any other material, size, components, fastening technique etc. that are known to one of ordinary skill in the art, as long as the intents of the present invention are not altered.

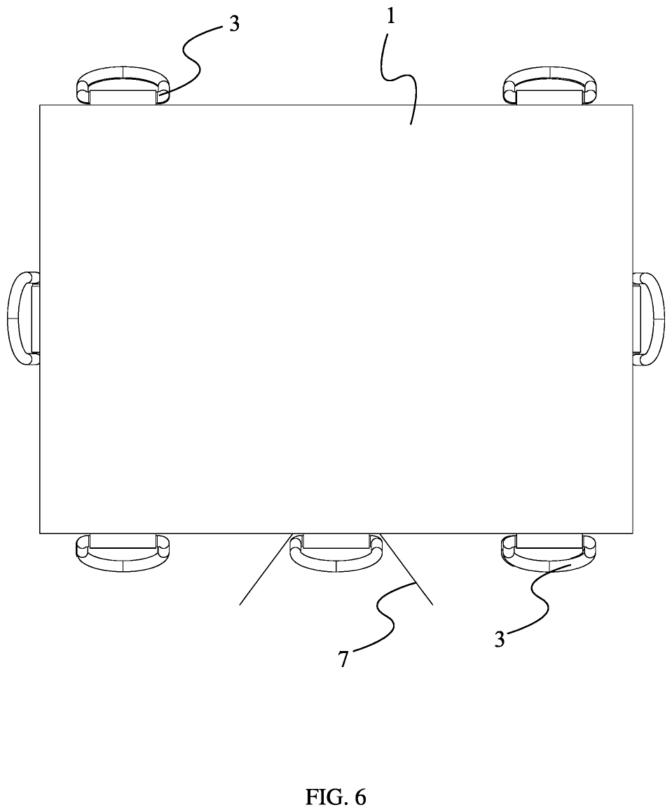

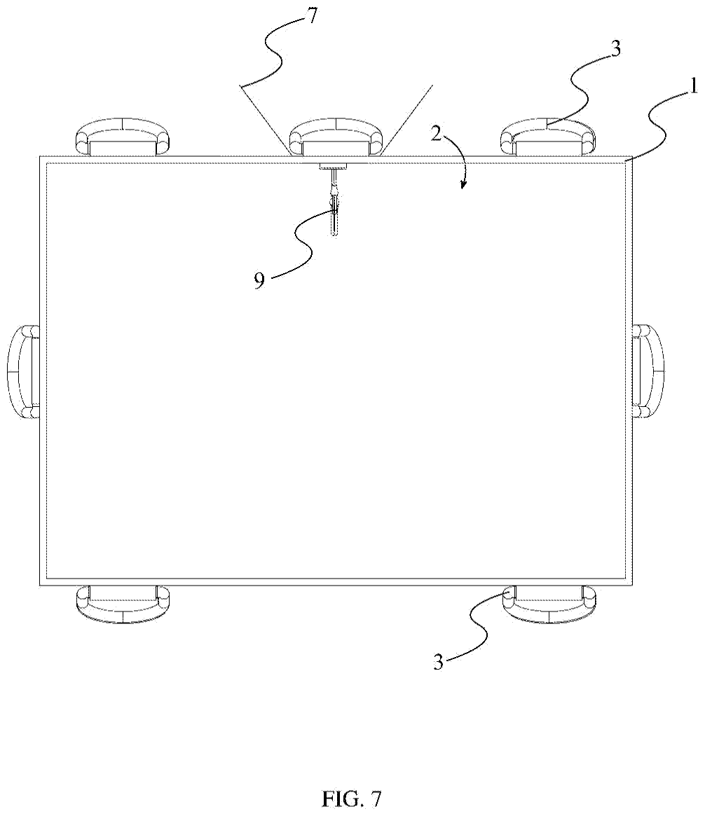

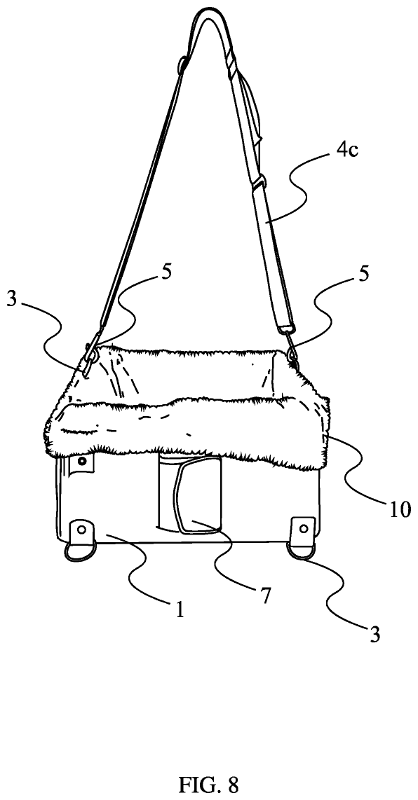

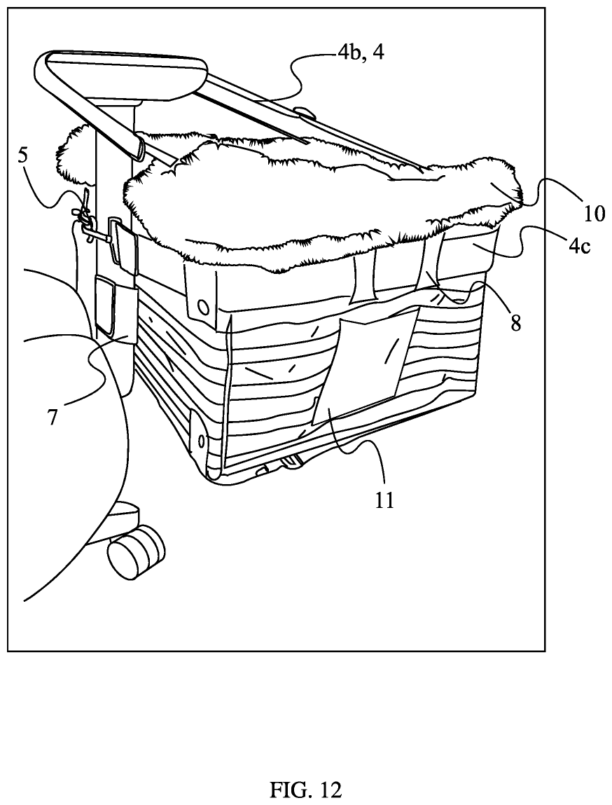

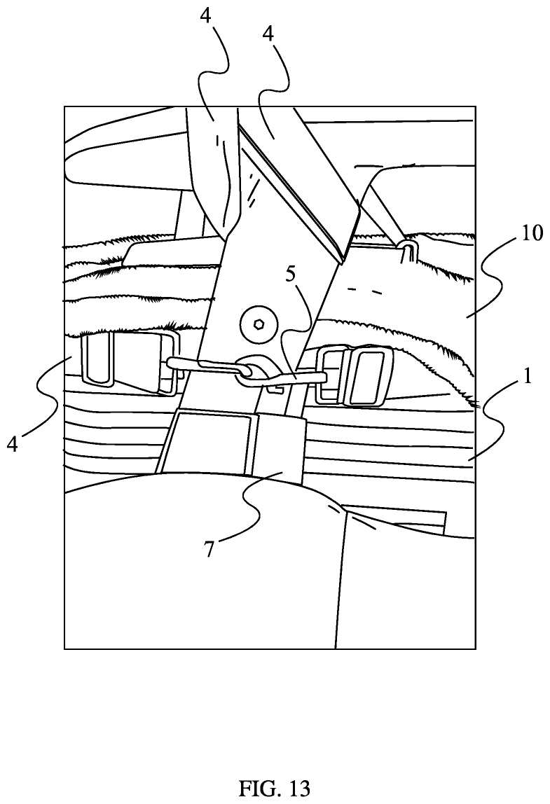

In reference to FIG. 4, FIG. 5, FIG. 8, FIG. 12 and FIG. 13, the present invention comprises a hook-and-loop chair attachment 7. Preferably, the hook-and-loop chair attachment 7 is laterally and centrally mounted onto a lateral sidewall of the receptacle 1, such that the hook-and-loop chair attachment 7 may assist in a safe and secure attachment between a chair and the present invention. The hook-and-loop chair attachment 7 is shown in an open position in FIG. 6 and FIG. 7. Preferably, the hook-and-loop chair attachment 7 flaps open in a similar motion as a book and is to be used by wrapping itself around an arm of a chair's handle. More specifically, the hook-and-loop chair attachment 7 has two flaps which overlap with one another as it wraps around the arm of a chair. The overlapping connects by means of a hook-and-loop surface or of the likes. As seen in FIG. 12 and FIG. 13, the hook-and-loop chair attachment 7 is wrapped around a handle of a chair, when the present invention is hung on a chair. Thus, the hook-and-loop chair attachment 7 safely and tightly secures the present invention to an arm of a chair.

In order to securely guide and hold the plurality of adjustable straps 4 around the receptacle 1, the present invention comprises a plurality of belt loops 8. In other words, the plurality of belt loops 8 is utilized with the plurality of adjustable straps 4 to assist the attachment to a chair and/or attaching to the car seat. Preferably, the plurality of belt loops 8 is laterally mounted onto the receptacle 1, and the plurality of belt loops 8 is positioned adjacent the first end 1a of the receptacle 1. In other words, the plurality of belt loops 8 is located adjacent the top end of the present invention. Further, as seen in FIG. 12, at least one of the plurality of adjustable straps 4 is threaded through the plurality of belt loops 8. Preferably, the plurality of belt loops 8 comprises a sturdy fabric sewn over a protective cover on the receptacle 1. However, it should be noted that the plurality of belt loops 8 may comprise any other material, location, orientation, and fastening mechanism that are known to one of ordinary skill in the art, as long as the intents of the present invention are not altered.

According to the preferred embodiment, the present invention comprises a leash fastener 9. As seen in FIG. 1, FIG. 2, FIG. 7, and FIG. 9, the leash fastener 9 is centrally mounted onto the inner compartment 2, adjacent the first end 1a of the receptacle 1. Preferably, the leash fastener 9 is a D-clip mounted onto the receptacle 1 to connect the pet to the receptacle 1. In other words, the leash fastener 9 is utilized in the present invention to safely secure and confine the pet's harness or collar into the present invention. To that end, the leash fastener 9 is detachably engaged to a leash of a pet resting within the inner compartment 2.

In order to provide comfort for the pet as well as for the user while handing the pet carrier, the present invention comprises a cover 10. Preferably, the cover 10 is a removable and washable liner for comfort and convenience in cases if the present invention needs to be washed. Accordingly, the cover 10 lines the inner compartment 2, the cover 10 is detachably connected to the receptacle 1, and the cover 10 is washable. Further, the cover 10 may be made of any soft material suitable for pets.

In reference to FIG. 1, the plurality of adjustable straps 4 comprises a first strap 4a, a second strap 4b, and a third shoulder strap 4c. Preferably the first strap 4a, the second strap 4b, and the third shoulder strap 4c are length adjustable and flexible. More specifically, the first strap 4a and the second trap 4b of the present invention are utilized to attach and support the present invention to a chair. In the preferred embodiment, the first strap 4a and the second strap 4b are made out of soft sturdy fabric, material similar to a standard backpack strap, or of the likes. Further, the first strap 4a and the second strap 4b may be adjusted to a variety of lengths and sizes needed for the user. It is important to note that the first strap 4a and the second strap 4b may come in different shape and sizes as well as utility purposes. In reference to FIG. 9 through FIG. 14, the first strap 4a, the second strap 4b, and the third shoulder strap 4c are wrapped around a passenger seat of a car or a chair.

In reference to FIG. 8, the third shoulder strap 4c is shown. The third shoulder strap 4c is utilized to assist the transportation of the pet carriage by wrapping over the shoulder of the user. In addition, the third shoulder strap 4c is utilized to attach and support the present invention to a chair, as seen in FIG. 12. and FIG. 13. The third shoulder strap 4c is made out of soft sturdy fabric, material similar to a standard backpack strap, or of the likes. Further, the third shoulder strap 4c can be adjusted to a variety of lengths and sizes needed for the user. Furthermore, in the preferred embodiment, the third shoulder strap 4c is thicker than the first strap 4a and the second strap 4b. However, the first strap 4a, the second strap 4b, and the third shoulder strap 4c may comprise any other size, shape, thickness, and fastening technology as long as the intents of the present invention are not altered.

As seen in FIG. 12, the present invention comprises a pocket 11, wherein the pocket 11 is laterally mounted onto the receptacle 1. The pocket 11 allows the user to store and hold any items or accessories alongside their pet carriage. Preferably, the pocket 11 is made of the same fabric as that of the cover 10. However, the pocket 11 may comprise any other material, size, components, location, orientation, etc. as long as the intents of the present invention are not hindered.

Although the invention has been explained in relation to its preferred embodiment, it is to be understood that many other possible modifications and variations can be made without departing from the spirit and scope of the invention as hereinafter claimed.

What is claimed is:

1. A pet carrying device comprising:
a receptacle;
an inner compartment;
a plurality of fastening loops;
a plurality of adjustable straps;
each of the plurality of adjustable straps comprising a plurality of fastening clips;
the inner compartment traversing into the receptacle;
the inner compartment extending from a first end of the receptacle towards a second end of the receptacle, wherein the first end being positioned opposite to the second end across the receptacle;
the plurality of fastening loops being laterally and perimetrically mounted onto the receptacle;
each of the plurality of fastening clips being terminally mounted onto a corresponding strap, wherein the corresponding strap is from the plurality of adjustable straps;
each of the plurality of fastening clips being removably engaged with a corresponding loop, wherein the corresponding loop is from the plurality of fastening loops; and
the plurality of adjustable straps being detachably connected to the receptacle, such that the receptacle may be detachably mounted onto a chair.

2. The pet carrying device of claim 1, wherein the plurality of adjustable straps being wrapped around a chair or a passenger seat of a car.

3. The pet carrying device of claim 1, comprising:
a hook and loop chair attachment;
the hook and loop chair attachment being laterally and centrally mounted onto a lateral sidewall of the receptacle.

4. The pet carrying device of claim 2, wherein the hook and loop chair attachment being wrapped around a handle of a chair.

5. The pet carrying device of claim 1, comprising:
a plurality of belt loops;
the plurality of belt loops being laterally mounted onto the receptacle; and
the plurality of belt loops being positioned adjacent the first end of the receptacle.

6. The pet carrying device of claim 4, wherein at least one of the plurality of adjustable straps being threaded through the plurality of belt loops.

7. The pet carrying device of claim 1, wherein the plurality of fastening loops being positioned adjacent the first end and adjacent the second end of the receptacle.

8. The pet carrying device of claim 1, comprising:
a leash fastener;
the leash fastener being laterally and centrally mounted onto the inner compartment, adjacent the first end of the receptacle.

9. The pet carrying device of claim 7, wherein the leash fastener being detachably engaged to a leash of a pet resting within the inner compartment.

10. The pet carrying device of claim 1, comprising:
a cover;
the cover lining the inner compartment;
the cover being detachably connected to the receptacle; and
the cover being washable.

11. The pet carrying device of claim 1, the plurality of adjustable straps comprising:
a first strap;
a second strap;
a third shoulder strap; and
the first strap, the second strap, and the third shoulder strap being length adjustable and flexible.

12. The pet carrying device of claim 10, wherein the first strap and the second strap being wrapped around a chair or a passenger seat of a car.

13. The pet carrying device of claim 10, wherein the third shoulder strap being thicker than the first strap and the second strap.

14. The pet carrying device of claim 1, wherein the plurality of fastening loops being metallic D-rings.

15. The pet carrying device of claim 1, comprising:
a pocket;
the pocket being laterally mounted onto the receptacle.

16. A pet carrying device comprising:
a receptacle;
an inner compartment;
a plurality of fastening loops;
a plurality of adjustable straps;
a hook and loop chair attachment;
each of the plurality of adjustable straps comprising a plurality of fastening clips;
the inner compartment traversing into the receptacle;
the inner compartment extending from a first end of the receptacle towards a second end of the receptacle, wherein the first end being opposite to the second end across the receptacle;
the plurality of fastening loops being laterally and perimetrically mounted onto the receptacle;
each of the plurality of fastening clips being terminally mounted onto a corresponding strap, wherein the corresponding strap is from the plurality of adjustable straps;
the plurality of adjustable straps being detachably connected to the receptacle;
each of the plurality of fastening clips being removably engaged with a corresponding loop, wherein the corresponding loop is from the plurality of fastening loops; and
the hook and loop chair attachment being laterally and centrally mounted onto a lateral sidewall of the receptacle.

17. The pet carrying device of claim 16, wherein the hook and loop chair attachment being wrapped around a handle of a chair.

18. The pet carrying device of claim 1, the plurality of adjustable straps comprising:
a first strap;
a second strap;
a third shoulder strap; and
the first strap, the second strap, and the third shoulder strap being length adjustable and flexible.

19. The pet carrying device of claim 18, wherein the first strap and the second strap being wrapped around a chair or a passenger seat of a car.

20. The pet carrying device of claim 18, wherein the third shoulder strap being thicker than the first strap and the second strap.
